(19) United States
(12) Patent Application Publication
(10) Pub. No.: US 2021/0389790 A1
(43) Pub. Date: Dec. 16, 2021

(54) Voltage Regulator

(71) Applicant: Infineon Technologies AG, Neubiberg (DE)

(72) Inventors: Cristian-Valentin Raducan, Sebes (RO); Alina-Teodora Cirlescu, Cluj-Napoca (RO); Marius-Georghe Neag, Cluj-Napoca (RO)

(21) Appl. No.: 17/348,207

(22) Filed: Jun. 15, 2021

(30) Foreign Application Priority Data
Jun. 16, 2020 (DE) 102020115851.3

(51) Int. Cl. G05F 1/575; G05F 1/569

(52) U.S. Cl. CPC G05F 1/575; G05F 1/569

(57) ABSTRACT

In accordance with one embodiment, a voltage regulator includes a transistor having a load current path connecting an input node with an output node, wherein the input node is configured to receive an input voltage and the output node is configured to provide an output voltage. The voltage regulator further includes a main control loop coupled between the output node and a control electrode of the transistor and configured to control a voltage applied to the control electrode so that the output voltage matches a set-point. Furthermore, the voltage regulator includes a supplemental control loop that is coupled between the output node and the control electrode of the transistor and configured to detect a transient in the output voltage and to adjust the voltage applied to the control electrode in response to the detection of a transient. A corresponding method is described.

This application claims the benefit of German Application No. 102020115851.3, filed on Jun. 16, 2020, which application is hereby incorporated herein by reference in its entirety.

### TECHNICAL FIELD

The present disclosure relates to the field of voltage regulator circuits, in particular to a low-dropout regulator (LDO regulator) having a fast step response to abrupt load current changes.

### BACKGROUND

Voltage regulators (VREGs) with pass transistors coupled in series to the load are widely used in large integrated circuits (ICs) not only to provide stable supply voltages for various supply lines within the chip but also to separate supply lines at the same voltage in order to prevent or reduce coupling-in of noise and leakage. A typical example is separating the supply line of digital circuit portions, which are heavily impacted by switching noise, from the supply line of noise-sensitive analog circuit portions.

In such cases the VREG should minimize the transient overshoots or undershoots occurring in its regulated output voltage when the load current or the supply voltage abruptly varies. Usually, a decoupling capacitor is placed at the VREG output as a charge buffer that filters the transient step response to abrupt load changes. However, integrating sufficiently large capacitors or providing enough pins for external decoupling capacitors are expensive design choices which are not acceptable in many applications.

Apart from relying on large decoupling (filter) capacitors, typical approaches to improving the step response of an LDO regulator to load changes include: increasing the bandwidth of the voltage control loop; employing a high-slew rate error amplifier, and passive local feedback loops. However, the effectiveness of these approaches is limited as they tend to require large current consumption, and they only work with particular types of error amplifiers and pass transistors. In many cases, it is rather difficult to ensure the stability of the resulting LDO regulators because the circuitry that improves the transient response interferes with the operation of the voltage control loop.

In view of the above, there is room for improvement of LDO regulators with regard to their step response without requiring relatively large filter capacitors.

### SUMMARY

A voltage regulator is described herein. In accordance with one embodiment, the voltage regulator includes a transistor having a load current path connecting an input node with an output node, wherein the input node is configured to receive an input voltage and the output node is configured to provide an output voltage. The voltage regulator further includes a main control loop coupled between the output node and a control electrode of the transistor and configured to control a voltage applied to the control electrode so that the output voltage matches a set-point. Furthermore, the voltage regulator includes a supplemental control loop that is coupled between the output node and the control electrode of the transistor and configured to detect a transient in the output voltage and to adjust the voltage applied to the control electrode in response to the detection of a transient.

Moreover, a voltage regulation method is described. In accordance with one embodiment, the method includes providing an output voltage to a load using a transistor that has a load current path connecting an input node with an output node. The method further includes controlling—using a main control loop—a voltage applied to a control electrode of the transistor so that the output voltage matches a set-point; detecting a transient in the output voltage; and adjusting the voltage applied to the control electrode in response to the detection of a slope. In one specific embodiment the output of the transient detector may be AC-coupled to the control electrode of the transistor.

### BRIEF DESCRIPTION OF THE DRAWINGS

The invention can be better understood with reference to the following drawings and descriptions. The components in the figures are not necessarily to scale; instead emphasis is placed on illustrating the principles of the invention. Moreover, in the figures, like reference numerals designate corresponding parts. In the drawings:

FIG. 1 illustrates one example of a typical VREG structure;

FIG. 2 is an exemplary timing diagram illustrating the step response of the VREG of FIG. 1 to an abrupt increase of the load current;

FIG. 3 illustrates one embodiment of an improved VREG structure;

FIGS. 4a and 4b illustrate two exemplary implementations of a transient detector used in the embodiment of FIG. 3;

FIG. 5 is a flow chart illustrating the function of the circuit shown in FIG. 3;

FIG. 6 includes timing diagrams further illustrating the function of the circuit of FIG. 3

FIGS. 7a-7c and 8a-8b include various exemplary implementations of slope detection circuits which may be used in the transient detector of FIG. 4;

FIGS. 9a-9b and 10a-10b include various exemplary implementations of amplifiers which may be used in the transient detector of FIG. 5;

FIG. 11 is a circuit diagram illustrating one example of the transient detector composed of slope detectors constructed in accordance with FIG. 7b, and amplifiers constructed in accordance with FIG. 9a;

FIG. 12 is a circuit diagram illustrating one example of the transient detector composed of slope detectors constructed in accordance with FIG. 8a, and amplifiers constructed in accordance with FIG. 10; and

FIG. 13 is a circuit diagram illustrating one example of the transient detector composed of slope detectors constructed in accordance with FIG. 7c, and amplifiers constructed in accordance with FIG. 9a.

### DETAILED DESCRIPTION OF ILLUSTRATIVE EMBODIMENTS

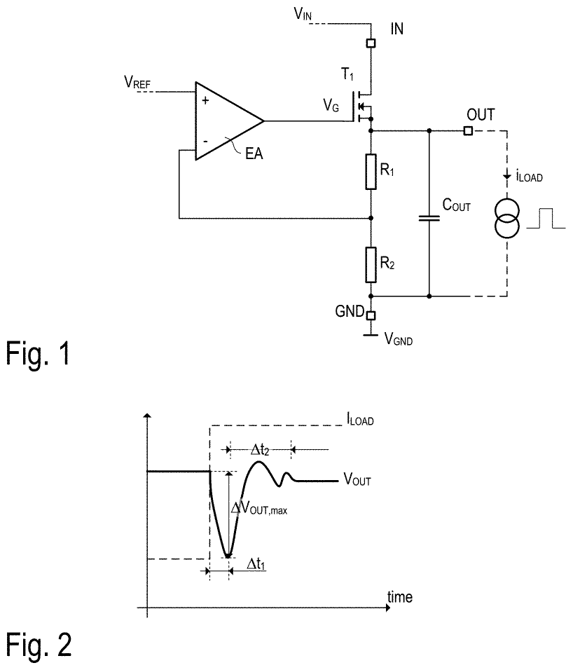

In the following detailed description, reference is made to the accompanying drawings. The drawings form a part of the description and, for the purpose of illustration, show examples of how the embodiments may be used and implemented. FIGS. 1 and 2 illustrate a simplified circuit diagram of a VREG and, respectively, its step response to abrupt load current changes in a situation, in which the output capacitor has a capacitance small enough to not dominate the step response.

According to the example of FIG. 1 an LDO regulator uses a pass transistor T₁ whose load current path is connected between an input node IN and an output node OUT to regulate the output voltage V_{OUT} available at the output node. The pass transistor may be an MOS field effect transistor (MOSFET) for which the load current path is usually referred to as the drain-source current path (equivalent to collector-emitter current path in case of bipolar transistors). N-type or P-type MOS transistors may be used (corresponds to NPN and PNP type in case bipolar transistors are used instead of MOS transistors). The control electrode of the transistor T₁, which is the gate in case of a MOS transistors and the base in case to a bipolar transistor, is connected to and driven by the output of an error amplifier EA, which is a difference amplifier such as, for example an operational amplifier. The error amplifier EA receives a reference voltage V_{REF} at its non-inverting input and a feedback voltage V_{FB} at its inverting input, and outputs the control voltage V_{G} (gate voltage in case of a MOS transistor) which is supplied to the control electrode of transistor T₁. The feedback voltage V_{FB} represents the output voltage V_{OUT}. In the depicted example, the feedback voltage V_{FB} is proportional to the output voltage V_{OUT}, wherein

$${V}_{F B} = \frac{{R}_{2}}{{R}_{1} + {R}_{2}} {V}_{O U T} . \qquad ( 1 )$$

That is, the voltage divider composed of the resistors R₁ and R₂ downscales the output voltage V_{OUT} to obtain the feedback voltage V_{FB}. The output capacitor C_{OUT} is connected between the output node OUT and ground node GND.

Given a step in the output current I_{LOAD} from 0 amperes to a maximum value I_{MAX} the maximum output voltage swing ΔV_{OUT,max} and the response time Δt₁ of the control loop can be approximated as follows:

$$\begin{matrix}Δ {V}_{OUT , max} ≅ Δ {t}_{1} \frac{{I}_{M A X}}{{C}_{O U T}} , and & ( 2 ) \\ Δ {t}_{1} ≅ \frac{1}{B {W}_{c l}} + {t}_{S R} = \frac{1}{B {W}_{c l}} + \frac{Δ V {C}_{P A R}}{{I}_{S R}} & ( 3 )\end{matrix}$$

wherein BW_{ci} is the closed-loop bandwidth of the system, t_{SR} is the time needed to charge the parasitic gate capacitance C_{PAR} of the pass transistor T₁, ΔV is the voltage swing at the gate of the pass transistor, and I_{SR} is the maximum current available to charge/discharge the parasitic gate capacitance C_{PAR}.

Apart from relying on large decoupling capacitors, typical approaches to improving the step response of an LDO regulator to load changes include: increasing the bandwidth of the voltage control loop; employing a high-slew rate error amplifier, and passive local feedback loops. However, the effectiveness of these approaches is limited as they tend to require large current consumption, and they only work with particular types of error amplifiers and pass transistors. In many cases, it is rather difficult to ensure the stability of the resulting LDO regulators because the circuitry that improves the transient response interferes with the operation of the voltage control loop.

The embodiments described herein aim at overcoming at least some of these issues. According to some embodiments, a circuit for detecting fast transients (transient detector), which does not interfere with the operation of the main voltage-control loop, is added to the typical VREG structure shown in FIG. 1. The transient detector may be used together with several types of error amplifiers such as, for example, Miller operational transconductance amplifiers (OTAs) or folded cascode OTAs. These can be used together with both, N-type and P-type, pass transistors and are effective in reducing the transient output voltage overshoot/undershoot caused by sharp variations of the load current I_{LOAD}.

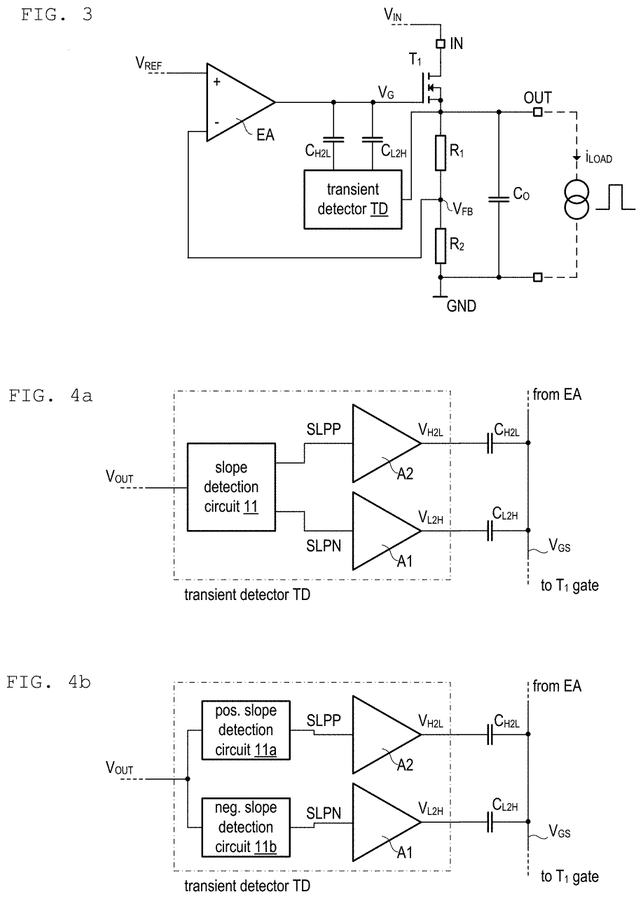

FIG. 3 illustrates one embodiment which includes the mentioned transient detector. The circuit of FIG. 3 is the same as in FIG. 1 except for the additional transient detector TD that is coupled to the output node to receive the output voltage V_{OUT}. Further, the transient detector has a first and a second output coupled to the gate electrode of the transistor T₁ via a first capacitor C_{L2H} and a second capacitor C_{H2L}, respectively. As can be seen in FIG. 3, the transient detector forms part of a second, fast control loop that can operate independent from the main control loop formed by the error amplifier EA. The transient detector TD is configured to detect the slope (amplitude and sign) of output voltage transients, and the information is conveyed to two (one for each sign, i.e. positive and negative slopes) amplifiers that directly drive the gate electrode of transistor T₁. The amplifiers are shown in FIG. 4a and FIG. 4b (denoted as amplifiers A₁ and A₂), illustrate two exemplary implementations of the transient detector TD of FIG. 3. Accordingly, the amplifiers A₁ and A₂ drive the gate of transistor T₁ only during output voltage transients and their outputs are AC-coupled (i.e. DC-decoupled) to the gate of transistor T₁ by using capacitors C_{H2L} and C_{L2H} (dependent on whether a positive or a negative slope is detected), so that in steady-state operation the transient detector TD does not interfere with the main voltage control loop. The example of FIG. 4a, includes one slope detection circuit 11 that is configured to detect positive slopes and negative slopes in the regulated output voltage Vo-r. Positive slopes are characterized by a positive time derivative (dV_{OUT}/dt>0) while negative slopes are characterized by a negative time derivative (dV_{OUT}/dt<0). The example of FIG. 4b, may be regarded as special case of the example of FIG. 4a. Accordingly, a first slope detection circuit 11a and a second detection circuit 11b are used to detect positive and, respectively, negative slopes.

When the value of the output voltage V_{OUT} decreases—for example, due to a suddenly increasing load current—the slope detection circuit 11 generates a signal SLPN at its first output, which indicates the detection of the (negative) slope. The amplifier A₁ receives the signal SLPN which triggers the injection of charge into (i.e. a charging of) the capacitor C_{L2H}. As capacitor C_{L2H} is connected between the output of amplifier A₁ and the gate of the transistor T₁, it follows that the gate voltage V_{G} (and thus also the gate-source voltage V_{G}S) of the transistor T₁ increases, which results in a lower on-resistance R_{ON} of the transistor load current path. Therefore, the voltage drop across the transistor load current path is reduced which counteracts the output voltage decrease; the value of the output voltage V_{OUT} again increases, even before the main voltage control loop (including the error amplifier EA) is able to react to the initial output voltage transient. Finally, the output voltage V_{OUT} is driven back to its steady-state value with the help of the main feedback loop.

Similarly, when the value of the output voltage V_{OUT} increases—for example, due to a suddenly decreasing load current—the slope detection circuit 11 generates a signal SLPP at its second output, which indicates the detection of the slope. The amplifier A₂ receives the signal SLPP which triggers a discharge of the capacitance C_{H2L} which is connected to the output of amplifier A₂. As capacitor C_{H2L} is connected between the output of amplifier A₂ and the gate of the transistor T₁, it follows that the gate voltage V_{G} of transistor T₁ decreases, which results in an increase of the transistors on-resistance R_{ON}. Therefore, the voltage drop across the transistor load current path is increased which counteracts the output voltage overshoot; the value of the output voltage V_{OUT} again decreases, even before the main voltage control loop is able to react to the initial output voltage transient. Finally, the output voltage V_{OUT} is driven back to its steady-state value with the help of the main feedback loop. It is understood that the slope detection circuit 11 may include a first slope detection circuit 11a for detecting positive slopes and a second slope detection circuit 11b for detecting negative slopes. In this case, which is illustrated in FIG. 4b, the first slope detection circuit 11a provides the signal SLPP and the second slope detection circuit 11b provides the signal SLPN.

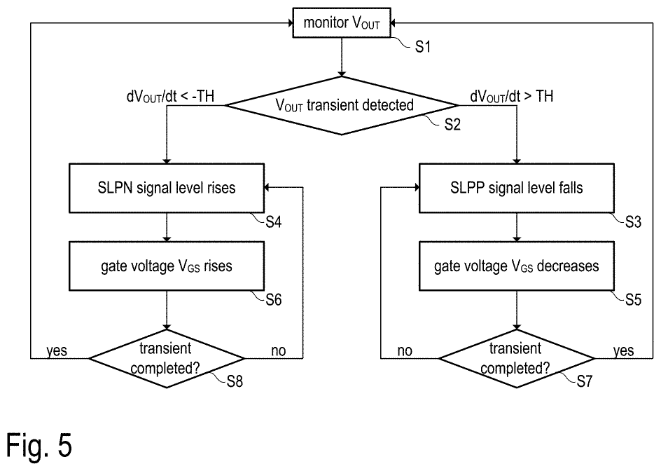

Before discussing various implementations of the transient detector TD, the function of the transient detector TD is explained using the flow chart of FIG. 5. During steady state, the transient detector TD has no effect on the regulated output voltage V_{OUT} because the transient detector is AC-coupled to (i.e. DC-decoupled from) the gate electrode of transistor T₁. That is, during steady state, the transient detector TD is merely monitoring the output voltage V_{OUT} (see FIG. 5, step S₁). As soon as a transient occurs in the output voltage V_{OUT}, the transient detector TD detects the transient (see FIG. 5, step S₂), wherein two cases are distinguished. At the onset of the transient the slope of the voltage V_{OUT} is either positive (dV_{OUT}/dt>0) or negative (dV_{OUT}/dt<0). The first case is indicated by the level of signal SLPP falling to a LOW level (see FIG. 5, step S₃, SLPP having a HIGH level during steady state and falls to lower values upon occurrence of a positive slope). Similarly, the second case is indicated by the level of signal SLPN rising to a HIGH level (see FIG. 5, step S₄, SLPN having a LOW level during steady state and rises to higher values upon occurrence of a negative slope). The signals SLPP and SLPN are amplified (cf. FIG. 3, amplifiers A₁ and A₂) and—due to the amplifiers A₁ and A₂ being AC coupled to the gate of transistor T₁—the gate voltage V_{G} decreases (see FIG. 5, step S₅) or increases (see FIG. 5, step S₆) thereby counteracting the respective transient. This mechanism (steps S₃ and S₅ or S₄ and S₆) is maintained as long as the output voltage changes, i.e. as long as the time derivative dV_{OUT}/dt of the output voltage V_{OUT} is positive or negative (see FIG. 5, steps S₇ and S₈). When the transient has decayed, the transient detector TD again monitors the output voltage V_{OUT} for a further transient (see FIG. 5, step S₁). As will be discussed later, the concept illustrated in FIG. 5 can be modified to ensure that the transient detector will only become active when the steepness of the slope is above a specific threshold value TH. In this case, the conditions illustrated in FIG. 5, step S2, are dV_{OUT}/dt>TH for positive slopes and dV_{OUT}/dt<−TH for negative slopes. It is understood that different threshold absolute values may be applied for positive and negative slopes. The threshold may be readily implemented by providing an offset current at the input of the amplifiers A₁, A₂ (see, e.g. FIG. 9, offset current i_{CLAMP}).

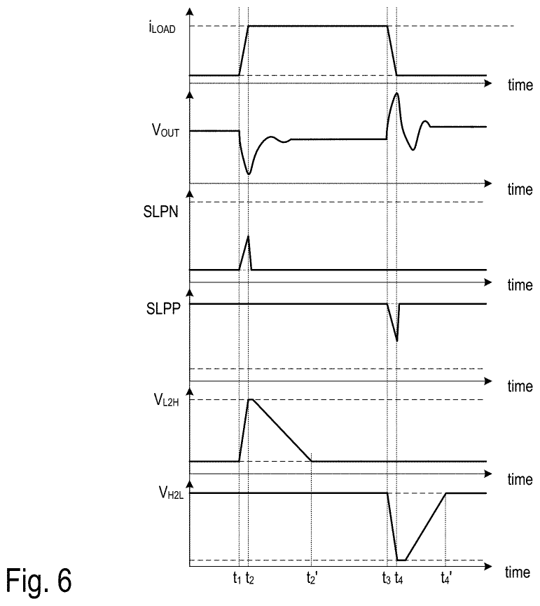

The mechanism explained above with reference to the flow chart of FIG. 5 is further illustrated by the timing diagrams of FIG. 6. In the example of FIG. 6, the load current i_{LOAD} rises from a relatively low level to a higher level at time instant t₁ and falls back to the initial low level at time t₃ (see top timing diagram of FIG. 6). As a result of the load current change transients occur in the output voltage signal V_{OUT}, wherein the first transient (at t₁) starts with a negative slope (due to the rising load current) and the second transient (at t₃) starts with a positive slope. The transients reach their respective maximum voltage swing at time instants t₂ and t₄, respectively (see second timing diagram of FIG. 6). The corresponding signals SLPN and SLPP generated by the slope detection circuit 11 (or the slope detection circuits 11b and 11a, respectively), are illustrated in the third and fourth timing diagram of FIG. 6.

As mentioned above, during steady state (for example before t₁) the signal SPLN is at a LOW level and the signal SLPP is at a HIGH level. At time t₁—i.e. at the onset of the negative slope—the signal SLPN rises to higher levels. Similarly, at time t₃—i.e. at the onset of the positive slope—the signal SLPP drops to lower levels. The signals SLPN and SLPP are amplified by amplifiers A₁ and A₂ (see FIGS. 3 and 4). These amplifiers may be current output amplifiers, and the output current of the amplifiers charge/discharge the coupling capacitors C_{L2H} and C_{H2L}. The corresponding amplifier output voltages V_{L2H} and V_{H2L} are shown in the fifth and the sixth diagram of FIG. 6. It is noted that it may take some time until the capacitor voltages and thus the voltages V_{L2H} and V_{H2L} return to their steady state values (see FIG. 6, times t₂′ and t₄′).

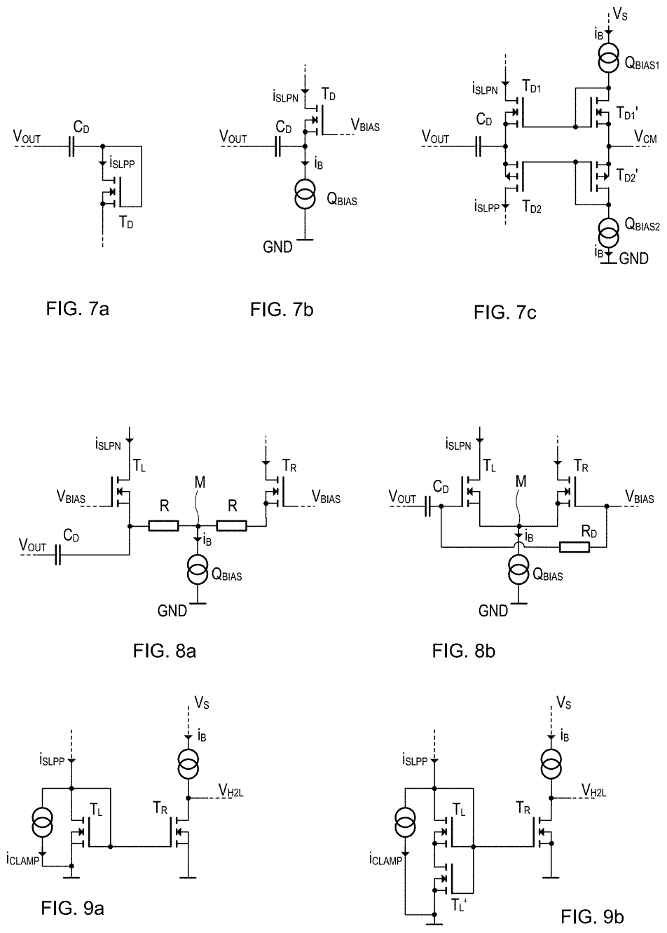

FIGS. 7 and 8 illustrate various exemplary implementations of slope detection circuits which may be used in the transient detector of FIGS. 3 and 4. In these implementations the slope detectors have a current output, i.e. the signals SPLN and SPLP are represented by currents i_{SLPN} and i_{SLPP}. For example, FIG. 7a illustrates a simple differentiator circuit composed of a capacitor C_{D} that is used as differentiator and connected to a transistor T_{D} operating as a MOS diode (i.e. a transistor T_{D} whose gate is biased with the drain voltage). The current i_{SLPP} passing through the capacitor C_{D} is substantially proportional to the (positive) time derivative dV_{OUT}/dt of the monitored output voltage. Various implementations of differentiator circuits exist. In an alternative example, the transistor is replaced by a simple resistor to obtain an RC differentiator circuit. In the examples described herein, a passive circuit element like a capacitor C_{D} is used as differentiator. It is understood that active differentiators may also be used instead, which e.g. include one or more operational amplifiers.

FIG. 7b illustrates a further exemplary implementation of a (negative) slope detection circuit. In this example, a bias current source Q_{BIAS} (providing current i) is connected between ground and the source electrode of a transistor T_{D} whose gate is biased with a constant volt V_{BIAS}. Further, the source electrode of transistor T_{D} is coupled to the output voltage V_{OUT} to be monitored. The bias voltage V_{BIAS} is set to a value such that the current source Q_{BIAS} remains active during negative slopes of the output voltage signal V_{OUT}. As a result, the drain current i_{SLPN} of transistor T_{D} increases above the value of bias current i_{B} in response to the negative slope of output voltage V_{OUT}.

FIG. 7c illustrates another exemplary implementation of a slope detection circuit, which is able to detect both, positive and negative slopes in the output voltage to be monitored. In this example, a first current mirror composed of n-channel MOS transistors T_{D1} and T_{D1}′ and a second current mirror composed of p-channel MOS transistors T_{D2} and T_{D2}′ are coupled in series as shown in FIG. 7c. Accordingly, the source electrodes of the transistors T_{D1}′ and T_{D2}′ are connected at a circuit node which is biased with a voltage V_{CM} (common mode voltage). The drain electrodes of the transistors T_{D1}′ and T_{D2}′ are connected with the respective gate electrodes. Thus, the transistors T_{D1}′ and T_{D2}′ form the input branches of the two current mirrors. Further, the drain electrode of transistor T_{D2}′ is coupled with a low supply potential (e.g. ground potential) via a current source Q_{BIAS2}. Similarly, the drain electrode of transistor T_{D1}′ is coupled with a high supply potential V_{S} via another current source Q_{BIAS1}. The load current paths of transistors T_{D1}′ and T_{D2}′ may be regarded as input branches of the current mirrors.

The source electrodes of transistors T_{D1} and T_{D2}, whose load current paths may be regarded as output branches of the current mirrors, are connected to each other at a circuit node that is coupled to the output voltage to be monitored via a capacitor C_{D}. The drain currents of transistors T_{D1} and T_{D2} are denoted as i_{SLPN} and, respectively, i_{SLPP} and represent the signals SLPN and SLPP discussed above and shown in FIG. 4. During steady state, the drain currents of T_{D1} and T_{D2} are equal to bias currents i_{B} set by current sources Q_{BIAS1} and, respectively, Q_{BIAS2}. During a negative slope of the output voltage V_{OUT}, the current passing through capacitor C_{D} will be subtracted from the common circuit node of the source electrodes of transistors T_{D1} and T_{D2}. As a result, the drain currents i_{SLPN} will increase and i_{SLPP} will decrease by the same difference amount. Similarly, a positive slope in the output signal V_{OUT} will cause a current through capacitor C_{D} that will be injected into the common circuit node of the source electrodes of transistors T_{D1} and T_{D2}. Consequently, the drain currents i_{SLPP} will increase and i_{SLPN} will decrease by the same amount. In essence, the examples of FIGS. 7b and 7c may be regarded as current buffers having a differentiator (differentiating element, capacitor C_{D}) coupled to their inputs.

FIG. 8 illustrates two further exemplary implementations of slope detection circuit, which make use of differential pairs (also known as long-tailed pairs). In the example of FIG. 8a, the source electrodes of transistors T_{L} and T_{R} are connected via two resistors R, wherein the common circuit node M between the two resistors R is coupled to the lower supply potential (ground potential) via a bias current source Q_{BIAS} providing a bias current i_{B}. The gate electrodes of both transistors T_{L} and T_{R} are biased with a bias voltage V_{BIAS}. The drain current of transistor T_{L} is the output current i_{SLPN}. The output voltage V_{OUT} to be monitored is coupled to the source electrode of transistor T_{L} via capacitor C_{D}. The example of FIG. 8b, is constructed very similar to the example of Fig. a. However, in FIG. 8b the resistors R can be omitted and the source electrodes are directly connected to circuit node N. Instead, a resistor R_{D} is connected between the gate electrodes of transistors T_{R} and T_{L}, and the output voltage V_{OUT} to be monitored is coupled to the gate electrode of transistor T_{L}. It is understood that differential pairs are commonly used in difference amplifiers and thus as such known to a skilled person and not discussed in greater detail herein.

FIG. 9 illustrates two exemplary implementations of current amplifiers that may be used in the transient detector of FIG. 4 (cf. FIG. 4, amplifiers A₁ and A₂). The two examples illustrated in FIGS. 9a and b, are based on a 1:K current mirror wherein K denotes the gain. According to the example of FIG. 9a, the load current path of transistor T_{L} forms the input branch and the load current path of transistor T_{R} forms the output branch of the current mirror. The gate electrodes of both transistors, T_{R} and T_{L}, are connected to the drain electrode of transistor T_{L} to form the current mirror. The input current i_{SLPP} is received at the drain electrode of the transistor T_{L} and the amplifier output voltage V_{H2L} is provided at the drain electrode of transistor T_{R}, which is coupled to the upper supply potential V_{S} via a current source providing the bias current i_{B}.

A further current source providing a current i_{CLAMP} is connected in parallel to the load current path of transistor T_{L}. This current i_{CLAMP} can be considered as an offset current subtracted from the current to be amplified. This offset current has the effect that the transient detector does not react to transient with relatively flat slopes. FIG. 9b illustrates a minor modification, in which a second transistor T_{L}′ is connected in series to transistors T_{L} to obtain an amplifier with a non-linear increasing gain.

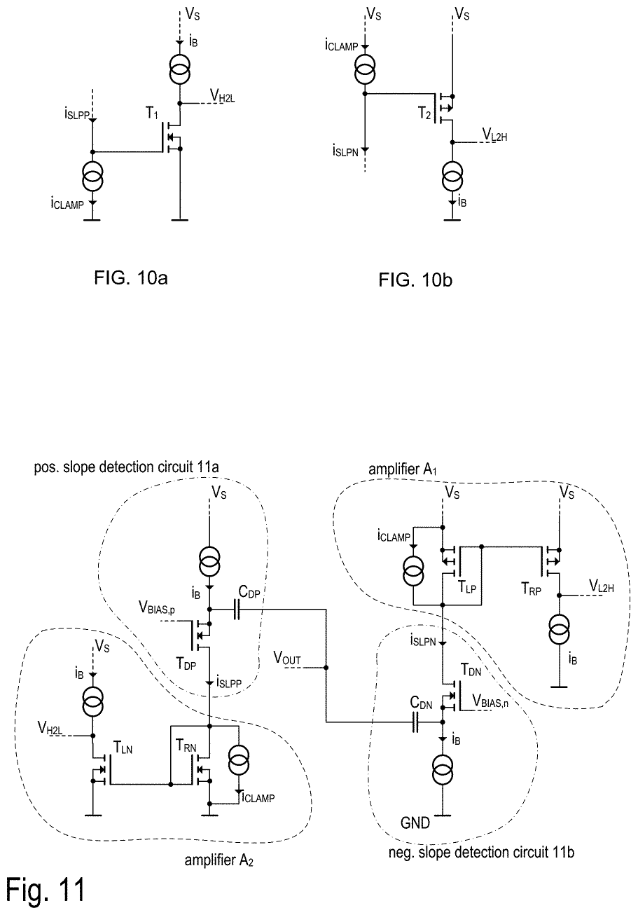

The examples of FIG. 10 illustrate two variants of a common-source amplifier stage which may be used as amplifiers A₁ and A₂ (see FIG. 4). The amplifier in FIG. 10a, uses an n-channel MOS transistor T₁ for amplifying the signal SLPP (current i_{SLPP}), whereas the amplifier in diagram (b) uses a p-channel MOS transistor T₂ for amplifying the signal SLPN (current i_{SLPN}). The drain electrodes of transistors T₁ and T₂ are connected to the (lower and, respectively, upper) supply voltage via current sources providing bias current i_{B}. Similar as in the previous examples of FIG. 9, current sources providing an offset current i_{CLAMP} are connected between the gate electrode of Transistor T₁ and T₂ and the (lower and, respectively, upper) supply voltage.

FIG. 11 illustrates one example of the transient detector TD which is composed of slope detection circuits 11a and 11b for detecting positive and, respectively, negative slopes in the output voltage V_{OUT} to be monitored and amplifiers A₁ and A₂. In the depicted example, the slope detection circuit 11b corresponds to the circuit of FIG. 7b. The slope detection circuit 11a is the complementary circuit using p-channel MOS transistor T_{DP} (instead of the n-channel MOS transistor T_{DN} used in the slope detection circuit 11b). The amplifier A₂ in FIG. 11 corresponds to the current mirror circuit of FIG. 9a. The amplifier A₁ in FIG. 11 is the complementary circuit using p-channel MOS transistors T_{LP} and T_{RP} (instead of the n-channel MOS transistors T_{LN} and T_{RN} used in amplifier A₂).

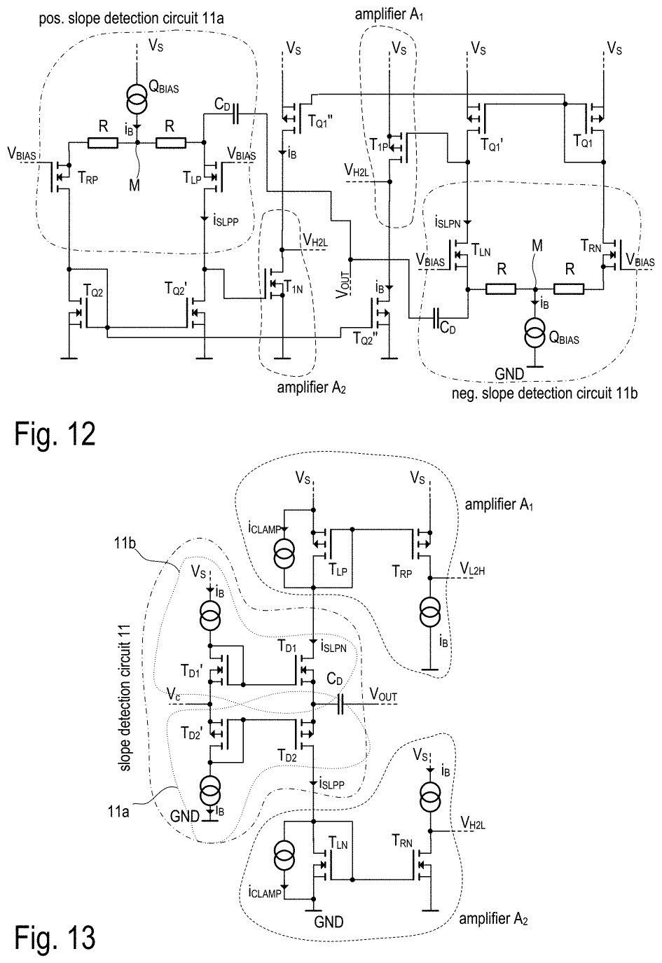

It is understood that the example of FIG. 11 can be modified by using the common-source amplifiers in accordance with FIG. 10a and FIG. 10b, as amplifiers A₂ and A₁, respectively (instead of the current mirror circuit of FIG. 9). A further embodiment may be obtained by combining differential pairs in accordance with FIG. 8 (as slope detectors) and current mirror circuits in accordance with FIG. 9 (as amplifiers). The example of FIG. 12 illustrates another example of the transient detector TD which is composed of slope detection circuits 11a and 11b, which are constructed as differential pairs in accordance with FIG. 8a, and amplifiers, which are constructed as common source circuits in accordance with FIG. 10. The differential pair forming the negative slope detection circuit 11b corresponds to the circuit of FIG. 8a. The positive slope detection circuit 11a is the complementary circuit which uses p-channel MOS transistors instead of n-channel MOS transistors. The differential pairs are loaded with current mirrors that are implemented by transistors T_{Q1}, T_{Q1}′ (for neg. slope detection circuit 11b) and T_{Q2}, T_{Q2}′ (for pos. slope detection circuit 11a). Transistors T_{Q1}′ and T_{Q2}′ are sized N times larger than T_{Q1} and, respectively, T_{Q2} such that they provide a suitable offset current which is subtracted from i_{SLPN} and, respectively, i_{SLPP}. Current mirrors as active loads for difference amplifiers are commonly known to a skilled person and thus not further discussed herein. In the current embodiment, the current mirrors have a further output branch formed by transistors T_{Q1}″ and T_{Q2}″ which are coupled as active loads to the drains of the transistors T_{1N} and, respectively, T_{1P}, which form the common source amplifiers A₂ and A₁. In the general example of FIG. 10, these active loads are symbolized by the current sources providing bias current i_{B}.

A further exemplary implementation of the transient detector TD is illustrated in FIG. 13. The depicted example is basically a combination of the slope detection circuit 11 of FIG. 7c, and the amplifiers A₁, A₂ constructed in accordance with FIG. 9a. Amplifier A₂ corresponds to the example of FIG. 9a, and amplifier A₁ is the complementary circuit using complementary transistor types (p-channel MOS transistors instead of n-channel MOS transistors). It is noted that the slope detection circuit 11 may be regarded as a combination of a positive slope detection circuit 11a, which is substantially formed by the current mirror of transistors T_{D2} and T_{D2}′, and a negative slope detection circuit 11b, which is substantially formed by the current mirror of transistors T_{D1} and T_{D1}′. Different to the previous examples of FIGS. 11 and 12, only one differentiator—capacitor C_{D}—is needed in the depicted example. The capacitor C_{D} is used by both parts 11a and 11b of the slope detection circuit 11.

Although the invention has been illustrated and described with respect to one or more implementations, alterations and/or modifications may be made to the illustrated examples without departing from the spirit and scope of the appended claims. In particular regard to the various functions performed by the above described components or structures (units, assemblies, devices, circuits, systems, etc.), the terms (including a reference to a “means”) used to describe such components are intended to correspond—unless otherwise indicated—to any component or structure, which performs the specified function of the described component (e.g., that is functionally equivalent), even though not structurally equivalent to the disclosed structure, which performs the function in the herein illustrated exemplary implementations of the invention.

What is claimed is:

1. A voltage regulator comprising:
a transistor having a load current path connecting an input node with an output node, the input node being configured to receive an input voltage and the output node being configured to provide an output voltage;
a main control loop coupled between the output node and a control electrode of the transistor and configured to control a voltage applied to the control electrode so that the output voltage matches a set-point; and
a supplemental control loop coupled between the output node and the control electrode of the transistor and configured to detect a transient in the output voltage and to adjust the voltage applied to the control electrode in response to the detecting the transient in the output voltage, wherein the supplemental control loop includes a slope detection circuit configured to provide a first signal indicating a detection of a negative slope, and a second signal indicating a detection of a positive slope.

2. The voltage regulator of claim 1, wherein the supplemental control loop further includes:
a first amplifier for amplifying the first signal; and
second amplifier for amplifying the second signal, the first amplifier and the second amplifier being AC-coupled to the control electrode of the transistor.

3. The voltage regulator of claim 2, wherein:
the first amplifier is connected to the control electrode of the transistor via a first capacitor; and
the second amplifier is connected to the control electrode of the transistor via a second capacitor.

4. The voltage regulator of claim 2, wherein the first amplifier and the second amplifier are current input amplifiers and/or current output amplifiers.

5. The voltage regulator of claim 2, wherein the first amplifier and the second amplifier include at least one of a current source transistor amplifier stage or a current mirror circuit.

6. The voltage regulator of claim 2, wherein the first amplifier and the second amplifier are current input amplifiers each comprising a current source connected to the current input of the respective amplifier, wherein the current source is configured to generate an offset current.

7. The voltage regulator of claim 1, wherein the first signal and the second signal, which are provided by the slope detection circuit, are current signals.

8. The voltage regulator of claim 1, wherein the slope detection circuit includes a differentiator.

9. The voltage regulator of claim 8, wherein:
the differentiator is implemented using a capacitor, or
the differentiator is an active differentiator circuit.

10. The voltage regulator of claim 1, wherein:
the slope detection circuit is configured to provide the first signal representing a time derivative of the output voltage, when the output voltage has the negative slope; and
the slope detection circuit is configured to provide the second signal representing the time derivative of the output voltage, when the output voltage has the positive slope.

11. The voltage regulator of claim 1, wherein the slope detection circuit includes at least one of: an RC differentiator circuit; a capacitor coupled to an input of a current buffer circuit; or a capacitor coupled to an input of a differential pair circuit.

12. The voltage regulator of claim 1, wherein the main control loop includes an error amplifier configured to receive a feedback voltage representing the output voltage and a reference voltage, the error amplifier having an output coupled to the control electrode of the transistor and providing an output signal that depends on a difference between the reference voltage and the output voltage.

13. The voltage regulator of claim 12, wherein the feedback voltage is provided at a middle tap of a voltage divider connected to the output node.

14. A method comprising:
providing an output voltage to a load using a transistor having a load current path connecting an input node with an output node;
controlling, using a main control loop, a voltage applied to a control electrode of the transistor so that the output voltage matches a set-point;
detecting a transient in the output voltage, wherein detecting the transient comprises generating a signal representing a time derivative of the output voltage; and
adjusting the voltage applied to the control electrode in response to the detection of a slope.

15. The method of claim 14, wherein detecting the transient comprises:
generating a first signal representing the time derivative of the output voltage when the time derivative is negative; and
generating a second signal representing the time derivative of the output voltage when the time derivative is positive.

16. The method of claim 15, wherein adjusting the voltage applied to the control electrode comprises:
amplifying the first signal or the second signal; and
coupling AC components of the amplified first signal and the amplifier second signal to the control electrode of the transistor to counteract the detected transient.

17. The method of claim 16, wherein:
amplifying the first signal comprises using a first amplifier having an output connected to the control electrode of the transistor via a first capacitor; and
amplifying the second signal comprises using a second amplifier having an output connected to the control electrode of the transistor via a second capacitor.

18. The method of claim 17,
wherein the first amplifier and the second amplifier are current input amplifiers; and
the method further comprises generating an offset current at the current input of the first amplifier and the second amplifier.

19. The method of claim 18, wherein:
the offset current defines a threshold; and
slopes having a steepness below an absolute value corresponding to the threshold are not amplified.

20. A circuit comprising:
an amplifier having an output configured to be coupled to a control node of a transistor, a first input configured to be coupled to an output node of the transistor, and a second input configured to be coupled to a reference voltage node;
a transient detection circuit having an input configured to be coupled to the output node of the transistor, the transient detection circuit comprising:
a first slope detection circuit configured to detect a voltage slope in a first direction at the output node of the transistor, the first slope detection circuit configured to be AC coupled to the control node of the transistor; and
a second slope detection circuit configured to detect a voltage slope in a second direction opposite the first direction at the output node of the transistor, the second slope detection circuit configured to be AC coupled to the control node of the transistor.

21. The circuit of claim 20, further comprising the transistor.
